(19) United States
(12) Patent Application Publication
(10) Pub. No.: US 2017/0301014 A1
(43) Pub. Date: Oct. 19, 2017

(54) APPARATUS AND METHOD FOR GENERATING A SCORE REPRESENTATIVE OF MORTGAGE QUALIFICATION AND PROVIDING RECOMMENDATIONS

(71) Applicant: KARL SINGER, DALLAS, TX (US)

(72) Inventor: KARL SINGER, DALLAS, TX (US)

(21) Appl. No.: 15/488,420

(22) Filed: Apr. 14, 2017

Related U.S. Application Data
(60) Provisional application No. 62/323,578, filed on Apr. 15, 2016.

(51) Int. Cl. G06Q 40/02

(52) U.S. Cl. CPC G06Q 40/025; G06Q 40/02

(57) ABSTRACT

One embodiment of a system comprises: a user database to store first data for a first user comprising data from one or more external sources related to the first user's ability to qualify for a mortgage and to store second data for the first user related to user responses to a questionnaire; a qualification engine to read the first data and second data from the user database, the qualification engine to perform an analysis of the first data and second data to determine a current qualification level for the first user; a recommendation engine to analyze the current qualification level generated by the qualification engine and to generate one or more recommended steps to improve the first user's current qualification level.

### CROSS REFERENCE TO RELATED APPLICATIONS

This application claims the benefit of and priority to co-pending U.S. Provisional Patent Application No. 62/323,578, filed, Apr. 15, 2016, all of which is herein incorporated by reference.

### BACKGROUND

### Field of the Invention

This invention relates generally to the field of computer systems. More particularly, the invention relates to a system and method for generating a score representative of mortgage qualification and providing recommendations.

### Description of the Related Art

Realtors and Lenders only really want to work with prospects who can buy today. That leaves the unmet desires and needs of some 30 million Millennial and other future home buyers on the table with no takers. They are intimidated by a complex and unaligned purchasing process that does not provide integrated technology support and seems incapable of directly responding to their concerns.

### BRIEF DESCRIPTION OF THE DRAWINGS

A better understanding of the present invention can be obtained from the following detailed description in conjunction with the following drawings, in which:

FIG. 1 illustrates an exemplary system and apparatus in accordance with one embodiment of the invention; and

FIG. 2 illustrates an exemplary computer system.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

One embodiment of the invention generates a score representing qualification of a user to acquire a mortgage or other type of loan. Should the user fall beneath a threshold qualification level, one embodiment provides specific recommendations as to how the user can improve his/her qualification score.

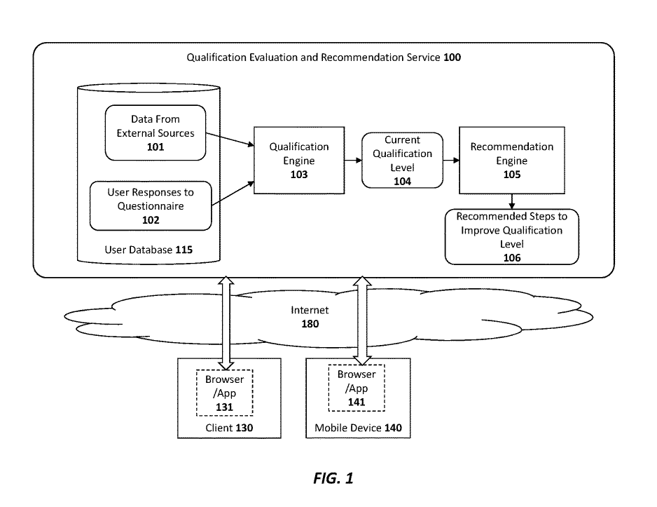

As illustrated in FIG. 1, one embodiment of the invention includes a qualification evaluation and recommendation service 100 to which user may connect over the Internet 180 via clients 130 and mobile devices 140 equipped with browsers and/or apps 131, 141, respectively, designed to connect with the service 100. In one embodiment, a qualification engine 103 executed on the service 100 determines a user's current qualification level 104 based on responses submitted by a user via a questionnaire 102 (e.g., such as the user's salary, assets, zip code, etc) and/or based on data from external sources 101 (e.g., such as the user's credit score). If the current qualification level 104 of the user is above some specified threshold (i.e., indicating that the user will qualify for a desired mortgage), then the user may be informed of the qualification. However, if the current qualification level 104 is below where it needs to be in order for the user to acquire a mortgage, then a recommendation engine 104 may evaluate the reasons for the user's low qualification level 104 and make recommendations comprising steps that the user may take to improve the user's qualification level 106 (e.g., reducing the user's debt).

One embodiment of the qualification engine 103 and recommendation engine 105 evaluate the following variables when determining a user's current qualification 104 and making recommendations 106 to improve the qualification level:

Employment:

Mortgage Underwriters examine employment history for the past two years in great detail. It is important to know what they are looking for in advance so the user can explain and resolve any issues that could deny the approval process!

Income:

In determining qualifying income, lenders examine the past two years of income history by requiring pay stubs, W2's and income tax returns. Before the user provides this information to a lender, he/she must make sure there are no issues that could get in the way of a mortgage approval.

Assets:

Many prospective homebuyers make the mistake of trying to be creative when moving money around to satisfy the funds required for closing. Lenders require all funds to be sourced and any unusual deposits explained. If not done properly, this can cause delays or even a mortgage denial.

Credit Score and Report:

Lenders examine credit scores and credit reports to evaluate a user's credit history. It is important to know that a high or low score is not everything. When it comes to qualifying, there are many different credit factors that impact the user's score. Mistakes and outdated items are common on reports and should be dealt with.

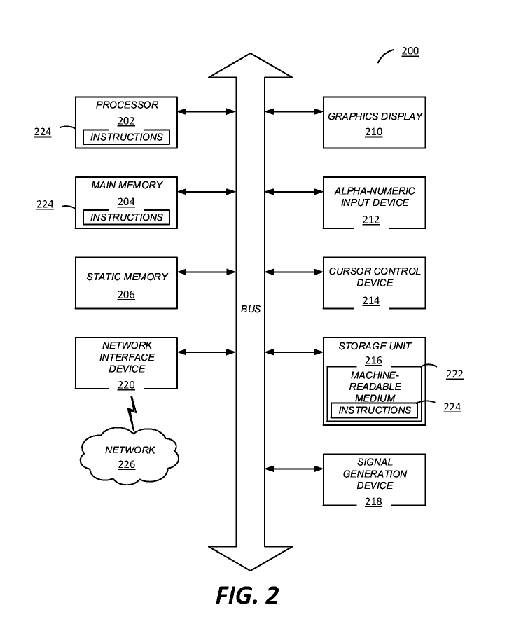

The various modules illustrated in FIG. 1 may be implemented in software, hardware, or any combination thereof. FIG. 2 illustrates an exemplary computing platform 200 on which the embodiments of the invention may be implemented. In particular, the exemplary computing platform 200 may be used to implement one or more servers of the qualification evaluation and recommendation service 100, the client 130, and/or mobile device 140.

The exemplary computer system 200 may execute program code stored on a machine-readable medium to implement the various techniques described herein. Specifically, FIG. 2 shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. As is further described below, this machine representation provides an example configuration to execute the processes described herein whether on the server side and/or client side.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

Various modifications, changes and variations, which will be apparent to those skilled in the art, may be made in the arrangement, operation and details of the method and apparatus disclosed herein without departing from the spirit and scope defined in the appended claims.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims.

We claim:

1. A mortgage evaluation and qualification system comprising:
a user database to store first data for a first user comprising data from one or more external sources related to the first user's ability to qualify for a mortgage and to store second data for the first user related to user responses to a questionnaire;
a qualification engine to read the first data and second data from the user database, the qualification engine to perform an analysis of the first data and second data to determine a current qualification level for the first user;
a recommendation engine to analyze the current qualification level generated by the qualification engine and to generate one or more recommended steps to improve the first user's current qualification level.

2. The system as in claim 1 wherein the first data comprises a credit score of the user.

3. The system as in claim 1 wherein the first data comprises a value of funds possessed by the user.

4. The system as in claim 1 wherein the first data or the second data comprises an income of the first user.

5. The system as in claim 1 wherein the second data comprises a desired mortgage amount and/or down-payment amount.

6. The system as in claim 1 further comprising:
a mobile device running an app configured to connect to the qualification engine and/or recommendation engine.
